(19) United States
(12) Patent Application Publication
(10) Pub. No.: US 2008/0024122 A1
(43) Pub. Date: Jan. 31, 2008

(54) Sensor including sensing areas delivering signals of differential amplitude

(76) Inventors: Pascal Desbiolles, Thorens Glieres (FR); Christophe Duret, Quintal (FR)

Correspondence Address: BACHMAN & LAPOINTE, P.C., 900 CHAPEL STREET, SUITE 1201, NEW HAVEN, CT, 06510, US

(21) Appl. No.: 11/879,836

(22) Filed: Jul. 19, 2007

(30) Foreign Application Priority Data
Jul. 27, 2006 (FR) 06 06908

(51) Int. Cl. G01B 7/00

(52) U.S. Cl. 324/207.25

(57) ABSTRACT

A pseudo-sinusoidal signal includes a plurality of sensing areas each of which are capable of delivering a signal Sᵢ representative of the signal to be detected. The sensing areas are arranged such that, for the same detected signal, at least one sensing area delivers a signal Sᵢ of a different amplitude than that of the signal delivered by another sensing area. Bearings may be equipped with such a sensor.

### BACKGROUND

(1) Field of the Invention

The invention relates to a pseudo-sinusoidal signal sensor, as well as bearings equipped with such a sensor.

The invention applies in particular to the field of determining angular data, such as the position or the speed of the rotating member of the bearing in relation to the stationary member of said bearing.

(2) Prior Art

In order to do so, it is known from the document FR-A1-2 792 403, to use an encoder capable of transmitting a pseudo-sinusoidal signal, and a sensor including a plurality of sensing elements which are linearly equally distributed, said sensing elements each being capable of delivering a signal Sᵢ representative of the signal transmitted by the encoder. This document further anticipates combining the signals Sᵢ in order to form two signals in quadrature and of the same amplitude, which are representative of the angular position of the rotating member in relation to the stationary member.

The invention also applies to the measurement of deformations as described, for example, in the document FR-A1-2 869 980, in which pseudo-sinusoidal signals in quadrature and of the same amplitude are formed by combining signals delivered by sensing areas.

In these two types of application, the prior art anticipates applying variable gains to the signals coming from the sensing areas so as to enable signals of the same amplitude to be delivered. Furthermore, these embodiments can make it possible to improve the delivered signal quality, in particular by carrying out spatial filtering, as well as by reducing sensitivity of the sensor to positioning errors or to performance defects of the encoder.

This amplification, carried out by means of an electronic amplifier, for example, has the following disadvantages in particular:
the noise is also amplified, so that the signal-to-noise ratio is not improved;
the amplifier-specific noise will be added to the signal;
the accessible gain ranges are limited by the supply voltage of the amplifiers.

Furthermore, when amplification is carried out on a signal that must be combined with a non-amplified signal, the signal-to-noise ratio will not be the same for these two signals, which can limit the performance levels of the associated devices.

### SUMMARY OF THE INVENTION

The purpose of the invention is to mitigate these disadvantages by proposing, in particular, a sensor the sensing areas of which are arranged so as to be able to do without electronic amplification of the delivered signals.

To that end, and according to a first aspect, the invention proposes a pseudo-sinusoidal signal sensor, said sensor including a plurality of sensing areas each of which are capable of delivering a signal Sᵢ representative of the signal to be detected, the sensing areas being arranged such that, for the same detected signal, at least one sensing area delivers a signal Sᵢ of a different amplitude than that of the signal delivered by another sensing area.

According to a second aspect, the invention proposes a bearing equipped with such a sensor, said bearing including a stationary member and a rotating member, in which an encoder delivering a pseudo-sinusoidal position signal is interconnected with the rotating member and the sensor is interconnected with the stationary member so that the sensing areas are arranged within reading distance of the signal transmitted by the encoder.

According to a third aspect, the invention proposes an antifriction bearing equipped with such a sensor, said bearing including a stationary member and a rotating member, between which rolling bodies are arranged in order to enable relative rotation thereof, by inducing a pseudo-sinusoidal deformation signal, wherein the sensing areas are interconnected with a member so as to detect said pseudo-sinusoidal signal.

### BRIEF DESCRIPTION OF THE DRAWINGS

Other characteristics and advantages of the invention will become more apparent in the following description made with reference to the attached figures, in which:

FIGS. 1a-1c show three alternatives for a first embodiment in the arrangement of the sensing elements of a sensor so as to form sensing areas delivering a specific amplitude signal, respectively;

FIGS. 2a and 2b show two alternatives for a second embodiment of a sensor designed to be capable of delivering two signals in quadrature and of the same amplitude.

### DETAILED DESCRIPTION OF THE PREFERRED EMBODIMENT(S)

The invention relates to a pseudo-sinusoidal signal sensor, i.e., any signal which is sinusoidal by nature and at least a portion of which can be correctly approximated by a sine curve.

To do so, the sensor includes a plurality of sensing areas 1, each of which is capable of delivering a signal Sᵢ which is representative of the signal being detected.

According to two specific applications, the pseudo-sinusoidal signal is an angular position signal for a rotating member in relation to a stationary member, or a periodic deformation signal for a structural element.

In the first application, anticipated in particular in the document FR-A1-2 792 403, the signal can be transmitted by a multipole magnetic encoder. As a matter of fact, by interconnecting this type of encoder with the rotating member, the transmitted signal is of a pseudo-sinusoidal nature and varies according to the angular position of said encoder in relation to the sensor. In order to detect the magnetic pseudo-sinusoidal signal, the sensing areas 1 can include, in particular, Hall effect sensors or magnetoresistors.

In the second application, anticipated in particular by the document FR-A1-2 869 980, the signal is induced by the periodic deformations of the structural element, and the sensing areas 1 are strain gauges arranged on said element. In particular, the strain gauges can be of a resistive, surface acoustic wave type or of a magnetic type.

However, the invention is not limited to these two specific applications, and can be applied to another type of pseudo-sinusoidal signal, e.g., whether it be of a mechanical, optical, thermal or acoustic nature, the nature of the sensing areas 1 then being chosen accordingly, in order to be capable of sensing the signal used.

According to the invention, the sensing areas 1 are designed so that, for the same detected signal, at least one sensing area 1 delivers a signal Sᵢ of a different amplitude from that of the signal delivered by another sensing area 1. Thus, by adjusting the respective amplitude of the signals Sᵢ via a specific layout of the sensing areas 1, it is possible to do without subsequent amplification of said signals based on their anticipated use.

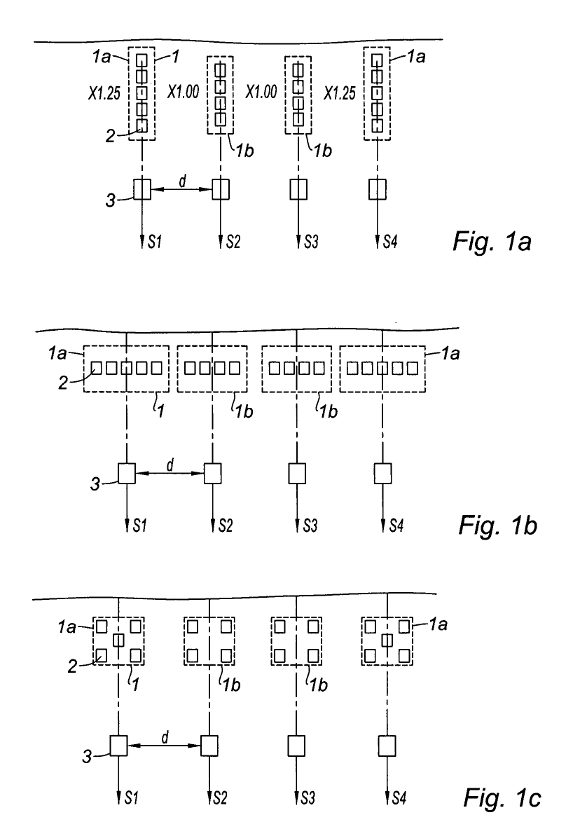

According to the embodiment shown in FIG. 1, the sensing areas 1 are linearly equally distributed. The sensing areas 1 include a plurality of sensing elements 2 the number of which is adjusted in order to deliver a signal Sᵢ of a specific amplitude.

To do so, the signal Sᵢ of the sensing area 1 is obtained by calculating the sum of the signals coming from each sensing element 2 of an area, owing to summation means provided for this purpose in the sensor.

FIG. 1, four sensing areas 1 are shown, the two lateral sensing areas la each delivering a signal S₁ and S₄ of amplitude 1.25 in relation to the amplitude of the signals S2, S₃ delivered by the inside sensing areas 1b. In order to accomplish this, the lateral areas 1a include five sensing elements 2 and the inside areas 1b include four sensing elements 2, said sensing elements being identical for all of the areas 1.

Furthermore, the sensing areas 1 are diagrammed by a larger-sized element 3, which is positioned at the barycentre of the area 1, the elements being aligned and equally spread apart by a specific distance d based on the pseudo-sinusoidal signal to be detected. Thus, the elements 3 correspond to the equivalent virtual measurement points with the desired gains.

By providing for the sensor to include linear combination means for the signals Sᵢ, it is possible, in a known manner, to form two pseudo-sinusoidal signals which are in quadrature and of the same amplitude, and to do so without using amplification. Thus, it is possible to use said signals, in particular for determining the angular position with an interpolator, or for determining the amplitude of the pseudo-sinusoidal signal.

Alternatively, it is also possible to combine the signals Sᵢ so as to form a pseudo-sinusoidal signal which corresponds to a spatial filtering of the signal transmitted by the encoder.

According to a first alternative of FIG. 1a, the sensing elements 2 are arranged perpendicular to the direction of alignment of the sensing areas 1, in a linearly equally distributed manner in this direction. Of course, the length of the stack of sensing elements 2 on an area 1 is designed so that each sensing element 2 detects a signal of a substantially identical amplitude.

According to the second alternative of FIG. 1b, the sensing elements 2 are arranged in the direction of alignment of the sensing areas 1, in a linearly equally distributed manner in this direction.

According to the third alternative of FIG. 1c, the sensing area 1 has a substantially square geometry, the four elements 2 being arranged in the vicinity of the corners, and the fifth sensing element 2 of the lateral areas 1a being arranged at the centre of said square.

Other distributions of the sensing elements 2 on the areas 1 can be anticipated, in particular with relation to the desired gain and the characteristics of the pseudo-sinusoidal signal. In particular, if the signal is uniform in amplitude along the vertical or horizontal axis, preference will be given to the arrangement according to the first and the second alternative, respectively. If the signal is uniform in amplitude in both directions, the three alternatives may be suitable.

The advantage of using a larger number of sensing elements 2 on an area 1 is the reduction in the measurement noise by a factor of (N)^{-1/2}, where N is the number of sensing elements 2. Furthermore, the invention makes it possible to improve the signal-to-noise ratio as well as the range of usable gains.

According to another embodiment not shown, at least one sensing area 1 includes at least one sensing element 2, which is designed to deliver a signal Sᵢ of a specific amplitude. In particular, it is possible to adjust the amplitude of the signal Sᵢ of a sensing area 1 by varying a parameter of the sensing element 2. In particular examples, the parameter used is chosen from the group including the geometry of the sensing element 2, its bias, the material comprising it, or a combination of these parameters.

For example, for a Hall effect sensor, the amplitude of the output signal can be increased by:
using another material with a larger Hall constant;
increasing the bias current of the sensor;
decreasing its width.

In the case of a thick-film strain gauge (piezoresistor), the voltage response can be increase by:
increasing the bias current of the gauge;
modifying its geometric dimensions;
using a different Young's modulus gauge support;
using a material having a higher resistivity.

Parameters of similar variations can be anticipated for other sensing element 2 technologies, for example:
the nature of the materials used or the physical characteristics thereof (doping, atomic structure, . . . );
the number of layers for a magnetoresistive technology;
the geometry or the shape of the sensing element 2;
the bias current or voltage of the sensing element 2.

Of course, the number of sensing elements 2 and the characteristics thereof can be combined so as to obtain the desired gain for the respective output signals.

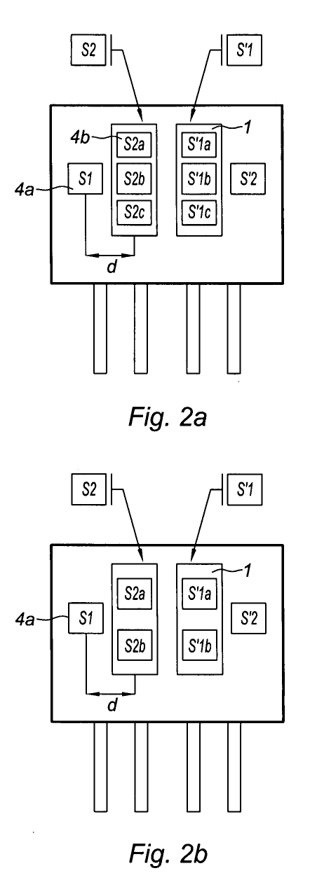

FIG. 2 show an embodiment of a sensor including four sensing areas 1 consisting of sub-areas 4, said sub-areas being arranged so that the barycentres of the areas 1 are linearly equally spread apart by a distance of d. The respective layout of the areas 1 is anticipated in order to be able to combine the signals coming from the sub-areas 4 in a particular way, so as to be able to form signals U and W of the same amplitude. In particular, the arrangements shown make it possible to obtain a gain of 2 at the inside virtual measurement points.

According to the first alternative of FIG. 2a, the sensor includes four identical sensing sub-areas which are linearly equally spread apart by a distance of d. The four sub-areas 4a deliver the signals S₁, S_{2b}, S′_{1b} and S′₂ of identical amplitude.

Each lateral area consists of a sub-area 4a. For each inside area, two additional sub-areas 4b, upper and lower, respectively, are provided, with an identical distance between the additional sub-areas 4b and the centre sub-area 4a, and the inside areas are identical. These additional sub-areas 4b deliver, respectively, the signals S₂ₐ, S_{2c}, S′₁ₐ, S′_{1c}, of identical amplitude.

The additional sub-areas 4b are each designed to deliver a signal having an amplitude two times smaller than that of the centre sub-area 4a.

Thus, assuming that the amplitude of the pseudo-sinusoidal signal of the encoder varies little or not at all along the axis perpendicular to the direction of alignment, it is possible to form the signals:
U=(S₁−S_{2b})−(S′_{1b}−S′₂)
W=(S₂ₐ+S_{2b}+S_{2c})−(S′₁ₐ+S′_{1b}+S′_{1c})

And, in the case where the distance d between the virtual measurement points is equal to one quarter of the spatial period of the sinusoidal signal being measured, the signals U and W have the same amplitude, and this is accomplished solely by constructing, and without amplifying, the signals coming from the sensing areas.

According to the second alternative of FIG. 2b, the sensor includes six identical sensing sub-areas 4a, the two inside areas each including two sub-areas distributed on both sides of the direction of alignment of the lateral areas. Thus, the two lateral areas each include one sub-area and the two inside areas each include two sub-areas.

The following signals can thus be formed:
U=(S₁−S₂ₐ)−(S′₁ₐ−S′₂) ; or
U=(S₁−S₂ₐ)−(S′_{1b}−S′₂) ; or
U=(S₁−S_{2b})−(S′₁ₐ−S′₂) ; or
U=(S₁−S_{2b})−(S′_{1b}−S′₂) ; and
W=(S₂ₐ+S_{2b})−(S′₁ₐ+S′_{1b}).

And, in the case where the distance d between the virtual measurement points is equal to one quarter of the spatial period of the sinusoidal signal being measured, the signals U and W have the same amplitude, and this is accomplished solely by constructing, and without amplifying, the signals coming from the sensing areas.

The invention also relates to two particular integrations of a sensor into a bearing including a stationary member and a rotating member.

According to a first embodiment, an encoder delivering a pseudo-sinusoidal position signal is interconnected with the rotating member and the sensor is interconnected with the stationary member, so that the sensing areas 1 are arranged within reading distance of the signal transmitted by the encoder.

According to a second embodiment, rolling bodies are arranged between the members in order to enable the relative rotation thereof, by inducing a pseudo-sinusoidal deformation signal. The sensing areas 1 are interconnected with a member so as to detect the pseudo-sinusoidal signal.

What is claimed:

1. Pseudo-sinusoidal signal sensor including a plurality of sensing areas each of which are capable of delivering a signal Sᵢ representative of a signal to be detected, said sensing areas being arranged such that, for the same detected signal, at least one sensing area delivers a first signal Sᵢ of a different amplitude than that of a second signal delivered by another sensing area.

2. Sensor of claim 1, wherein the sensing areas are linearly equally distributed.

3. Sensor as claimed in claim 1, further including linear combination means for the signals Sᵢ, said linear combination means being designed to form at least one pseudo-sinusoidal signal.

4. Sensor as claimed in claim 1, wherein said at least one sensing area includes a plurality of sensing elements, said sensing elements being adjusted in number in order to deliver a signal Sᵢ of a specific amplitude, and said sensor further including means for calculating a sum of the signals coming from each sensing element of said at least one sensing area, so as to form the signal Sᵢ for said at least one sensing area.

5. Sensor as claimed in claim 1, wherein said at least one sensing area includes at least one sensing element which is designed to deliver a signal Sᵢ of a specific amplitude.

6. Sensor of claim 5, wherein said at least one sensing element has a parameter which makes it possible to obtain the specific amplitude and which is chosen from a group consisting of a geometry of the at least one sensing element, a bias of the at least one sensing element, a material comprising of the at least one sensing element, and a combination thereof.

7. Sensor as claimed in claim 1, wherein the sensing areas consist of sensing sub-areas, and said sensor includes linear combination means for the signals coming from the sub-areas, so as to form at least one pseudo-sinusoidal signal.

8. Bearing equipped with a sensor as claimed in claim 1, said bearing including a stationary member and a rotating member, in which an encoder delivering a pseudo-sinusoidal position signal is interconnected with the rotating member and the sensor is interconnected with the stationary member so that the sensing areas are arranged within reading distance of the signal transmitted by the encoder.

9. Antifriction bearing equipped with a sensor as claimed in claim 1, said bearing including a stationary member and a rotating member, between which rolling bodies are arranged in order to enable relative rotation thereof, by inducing a pseudo-sinusoidal deformation signal, wherein the sensing areas are interconnected with a member so as to detect said pseudo-sinusoidal signal.
